(19) United States
(12) Patent Application Publication
(10) Pub. No.: US 2004/0179812 A1
(43) Pub. Date: Sep. 16, 2004

(54) Image recording and/or reproducing method and image processing apparatus

(75) Inventor: Shigeki Hamura, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/786,684

(22) Filed: Feb. 25, 2004

Related U.S. Application Data
(63) Continuation of application No. PCT/JP01/09446, filed on Oct. 26, 2001.

(51) Int. Cl. H04N 5/91

(52) U.S. Cl. 386/46

(57) ABSTRACT

An image recording and/or reproducing method is adapted to a system provided with a plurality of image processing apparatuses which have functions of recording and/or reproducing image data and are coupled via one or a plurality of networks. The method includes transmitting an instruction from a first image processing apparatus with respect to a second image processing apparatus by an electronic mail, and returning a status report related to the second image processing apparatus to the first image processing apparatus by an electronic mail, in response to the instruction received by the electronic mail.

### BACKGROUND OF THE INVENTION

This application is a Continuation Application, filed under 35 U.S.C. §111(a), of an International Application PCT/JP01/09446, filed Oct. 26, 2001.

1. Field of the Invention

The present invention generally relates to image recording and/or reproducing methods and image processing apparatuses, and more particularly to an image recording and/or reproducing method for recording and/or reproducing image data via a network, and to an image processing apparatus which employs such an image recording and/or reproducing method.

In this specification, the image recording and/or reproducing method refers to a method of recording and/or reproducing image data. Hence, the image recording and/or reproducing method may include at least one of recording image data and reproducing image data. In addition, the image processing apparatus includes video decks, video players, video recorders, video cameras, and computers such as personal computers. A recording medium which records the image data may be formed by any kind or type of media capable of recording the image data in a reproducible manner. For example, magnetic recording media such as magnetic tapes and magnetic disks, optical recording media such as optical disks and magneto-optical disks, and semiconductor memory devices such as RAMs, may be used as the recording medium for recording the image data.

2. Description of the Related Art

There is a conventional method of controlling a plurality of video decks from a controller to record and/or reproduce image data. The controller in this case controls each of the video decks independently. The image data reproduced on a certain video deck is displayed at a request source apparatus such as a computer, under the control of the controller.

However, if the length of the image data to be recorded is 3 hours, for example, but the length of a vacant region available in the recording medium within the video deck which is to record the image data is only 2 hours, not all of the image data can be recorded continuously. In order to continuously record all of the image data, it is necessary to change the recording medium within the video deck to a recording medium having an available vacant region with the length of 3 hours or more. Alternatively it is necessary to switch the video deck which is to record the image data to another video deck which has a recording medium capable of continuously recording the image data amounting to 3 hours.

However, in the first case where the recording medium is changed, a manager (or operator) must manually change the recording medium, and there were problems in that the recording operation requires a troublesome and time-consuming manual operation. In addition, if there is a request for the image data recorded in the original recording medium which was changed, there was another problem in that this request cannot be met unless the recording medium is changed back to the original recording medium. Moreover, in order for the manager to change the recording medium back to the original recording medium, it is necessary for the manager to manage information which indicates which image data are recorded in which recording media. Further, since the manager must manually change the recording medium if necessary based on the managed information, there were problems in that a troublesome and time-consuming manual operation is required to manage the information and to reproduce the image data.

On the other hand, in the second case where the video deck to be used is switched, the manager must manually switch the video deck to be used, and there were problems in that the medium switching operation requires a troublesome and time-consuming manual operation. In addition, in order to enable the requested image data to be reproduced, the manager must manage information related to the switching of the video deck which is to record the image data and information related to the video deck which is to actually record the image data. Consequently, there was a problem in that it is troublesome to manage such information.

Therefore, it was conventionally impossible to control one or a plurality of image processing apparatuses via one or more networks by use of a simple structure, and it was also impossible to automatically continue the recording and/or reproduction by linking operations of a plurality of image processing apparatuses via one or more networks.

### SUMMARY OF THE INVENTION

Accordingly, it is a general object of the present invention to provide a novel and useful image recording and/or reproducing method and image processing apparatus, in which the problems described above are eliminated.

Another and more specific object of the present invention is to provide an image recording and/or reproducing method and an image processing apparatus, which can control one or a plurality of image processing apparatuses via one or more networks by use of a simple structure, and automatically continue recording and/or reproduction by linking operations of a plurality of image processing apparatuses via one or more networks.

Still another object of the present invention is to provide an image recording and/or reproducing method adapted to a system comprising a plurality of image processing apparatuses which have functions of recording and/or reproducing image data and are coupled via one or a plurality of networks, comprising transmitting an instruction from a first image processing apparatus with respect to a second image processing apparatus by an electronic mail; and returning a status report related to the second image processing apparatus to the first image processing apparatus by an electronic mail, in response to the instruction received by the electronic mail. According to the image recording and/or reproducing method of the present invention, it is possible to control one or a plurality of image processing apparatuses via one or a plurality of networks, using a simple structure.

The image recording and/or reproducing method may further comprise continuing recording or reproduction by linking operation with an image processing apparatus which is other than the second image processing apparatus and is coupled to the one or plurality of networks, depending on a state of the second image processing apparatus. In this case, it is possible to automatically continue the recording and/or reproduction by linking operations of a plurality of image processing apparatuses via one or a plurality of networks.

The instruction included in the electronic mail may include one of a record instruction, a reproduce instruction and a status request; the record instruction may include an apparatus name of the second image processing apparatus, a specified recording material, a start time and an end time; the reproduce instruction may include an apparatus name of the second image processing apparatus, a specified reproducing material, a start time and an end time; and the status request may include an operating state of the second image processing apparatus, a vacant memory capacity within the second image processing apparatus, and a list of reproducible contents, where the operating state of the second image processing apparatus may include a recording state, a reproducing state and a standby state.

The first image processing apparatus may functions as a master apparatus, and one or a plurality of image processing apparatuses coupled to a network to which the first image processing apparatus is coupled may function as slave apparatuses.

A further object of the present invention is to provide an image recording and/or reproducing method adapted to a system comprising a plurality of image processing apparatuses which have functions of recording and/or reproducing image data and are coupled via one or a plurality of networks, comprising transmitting an instruction from a first image processing apparatus with respect to a second image processing apparatus; returning a status report related to the second image processing apparatus to the first image processing apparatus, in response to the received instruction; and continuing recording or reproduction by linking operation with an image processing apparatus which is other than the second image processing apparatus and is coupled to the one or plurality of networks, depending on a state of the second image processing apparatus. According to the image recording and/or reproducing method of the present invention, it is possible to control one or a plurality of image processing apparatuses via one or a plurality of networks, using a simple structure. In addition, it is possible to automatically continue the recording and/or reproduction by linking operations of a plurality of image processing apparatuses via one or a plurality of networks.

Another object of the present invention is to provide an image processing apparatus connectable to a network and having functions of recording and/or reproducing image data, comprising a unit to transmit an instruction with respect to a receiving end image processing apparatus via the network by an electronic mail; and a unit to return a status report to a transmitting end image processing apparatus via the network by an electronic mail, in response to the instruction of the electronic mail which is received via the network. According to the image processing apparatus of the present invention, it is possible to control one or a plurality of image processing apparatuses via one or a plurality of networks, using a simple structure.

The image processing apparatus may further comprise a unit to continue recording or reproduction by linking operation with one or a plurality of other image processing apparatuses which are coupled to the network, depending on a state of the image processing apparatus. In this case, it is possible to automatically continue the recording and/or reproduction by linking operations of a plurality of image processing apparatuses via one or a plurality of networks.

The instruction included in the electronic mail may include one of a record instruction, a reproduce instruction and a status request; the record instruction may include an apparatus name of the receiving end image processing apparatus, a specified recording material, a start time and an end time; the reproduce instruction includes an apparatus name of the receiving end image processing apparatus, a specified reproducing material, a start time and an end time; and the status request may include an operating state of the receiving end image processing apparatus, a vacant memory capacity within the receiving end image processing apparatus, and a list of reproducible contents, where the operating state of the receiving end image processing apparatus may include a recording state, a reproducing state and a standby state.

Still another object of the present invention is to provide an image processing apparatus connectable to a network and having functions of recording and/or reproducing image data, comprising a unit to transmit an instruction with respect to a receiving end image processing apparatus via the network, when the image processing apparatus operates as a transmitting end; a unit to return a status report to a transmitting end image processing apparatus via the network, in response to the instruction which is received via the network, when the image processing apparatus operates as a receiving end; and a unit to continue recording or reproduction by linking operation with an image processing apparatus which is coupled to the network aid is other than the receiving end image processing apparatus, depending on a state of the image processing apparatus when the image processing apparatus operates as the receiving end. According to the image processing apparatus of the present invention, it is possible to control one or a plurality of image processing apparatuses via one or a plurality of networks, using a simple structure. In addition, it is possible to automatically continue the recording and/or reproduction by linking operations of a plurality of image processing apparatuses via one or a plurality of networks.

Other objects and further features of the present invention will be apparent from the following detailed description when read in conjunction with the accompanying drawings.

### BRIEF DESCRIPTION OF THE DRAWINGS

FIG. 1 is a system block diagram showing a system to which a first embodiment of an image recording and/or reproducing method according to the present invention may be applied;

FIG. 2 is a flow chart for explaining an instruction process of an image processing apparatus;

FIG. 3 is a diagram showing an embodiment of an instruction mail format;

FIG. 4 is a diagram showing an embodiment of a report mail format;

FIG. 5 is a flow chart for explaining a recording continue process of the image processing apparatus;

FIG. 6 is a flow chart for explaining a reproduction continue process of the image processing apparatus; and

FIG. 7 is a system block diagram showing a system to which a second embodiment of the image recording and/or reproducing apparatus may be applied.

### DESCRIPTION OF THE PREFERRED EMBODIMENTS

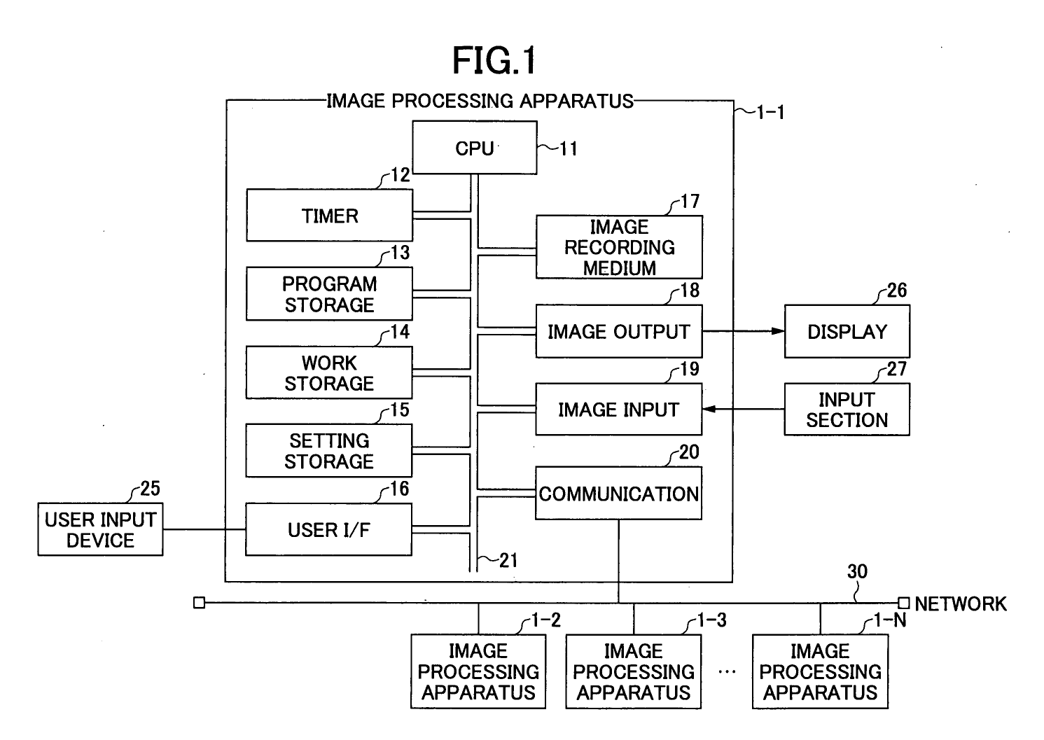

FIG. 1 is a system block diagram showing a system to which a first embodiment of an image recording and/or reproducing method according to the present invention may be applied. The system shown in FIG. 1 includes image processing apparatuses 1-1 through 1-N which are connected via a network 30. A unique apparatus name or ID is given to each of the image processing apparatuses 1-1 through 1-N. For example, the apparatus names of the image processing apparatuses 1-1 through 1-N may be numbers such as 1 to N. Each of the image processing apparatuses 1-1 through 1-N is formed by a video deck, a video player, a video recorder, a video camera, or a computer such as a personal computer, and includes functions of recording and/or reproducing image data. It is assumed for the sake of convenience that the image processing apparatuses 1-1 through 1-N have the same structure, and only the structure of the image processing apparatus 1-1 is shown in FIG. 1. Each of the image processing apparatuses 1-1 through 1-N forms the first embodiment of the image processing apparatus according to the present invention.

The image processing apparatus 1-1 includes a CPU 11, a timer 12, a program storage 13, a work storage 14, a setting storage 15, a user interface (I/F) 16, an image recording medium 17, an image output circuit 18, an image input circuit 19, and a communication circuit 20 which are connected via a bus 21. In this embodiment, the basic structure of the image processing apparatus 1-1 is similar to the basic structure of a known personal computer.

The CPU 11 controls the entire operation of the image processing apparatus 1-1. The timer 12 manages times which are used for controlling timings of various processes carried out by the CPU 11. The program storage 13 stores programs to be executed by the CPU 11, and the work storage 14 provides a work area to be used when the CPU 11 carries out various processes. The setting storage 15 stores various settings with respect to various processes which will be described later. The program storage 13, the work storage 14 and the setting storage 15 may be formed by different storage areas of a single storage unit or, formed by storage areas of two or more storage units. In this case, the storage unit to be used as the program storage 13, the work storage 14 and the setting storage 15 is not limited to a specific kind or type. The user interface 16 provides an interface between the image processing apparatus 1-1 and a user input device 25 such as an operation panel and a keyboard.

The image recording medium 17 is used to record image data. The image recording medium 17 may be formed by any kind or type of media capable of recording the image data in a reproducible manner. For example, magnetic recording media such as magnetic tapes and magnetic disks, optical recording media such as optical disks and magneto-optical disks, and semiconductor memory devices such as RAMs, may be used as the image recording medium 17. The recording medium forming the image recording medium 17 may form at least a portion of the program storage 13, the work storage 14 and the setting storage 15.

The image output circuit 18 converts image data to be displayed into image data having a format suited for display on a display unit 26, and outputs the converted image data to the display unit 26. The display unit 26 is formed by a known display device such as a CRT and an LCD, and displays the received image data. The image data displayed on the display unit 26 may be reproduced from the image recording medium 17 within the image processing apparatus 1-1 or, reproduced in other image processing apparatuses such as the image processing apparatus 1-2.

The image input circuit 19 inputs the image data to be recorded in the image recording medium 17 from an input section 27, and converts the image data into image data having a format suited for recording in the image recording medium 17. For example, in a case where the input section 27 is formed by a camera, the image data related to an image which is picked up, that is, imaged, by the camera, is input to the image input circuit 19. In a case where the input section 27 is formed by an antenna, the image data of a television signal or the like received by the antenna, is input to the image input circuit 19 wherein the image data of a selected channel (station) is obtained.

The communication circuit 20 controls the communication between the image processing apparatus 1-1 and at least one of the other image processing apparatuses 1-2 through 1-N, via the network 30. In this embodiment, the image processing apparatuses 1-1 through 1-N communicate by electronic mail via the network 30, and thus, the communication circuit 20 is provided with a known electronic mail function for transmitting and receiving electronic mail.

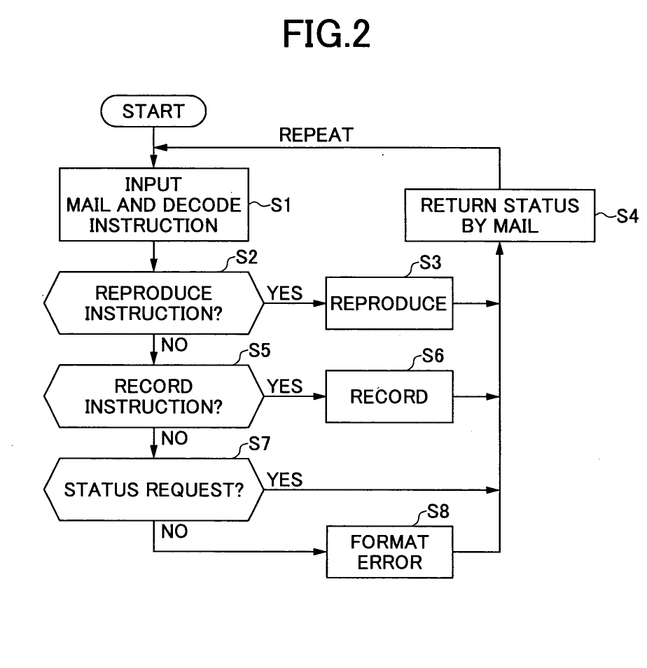

FIG. 2 is a flow chart for explaining an instruction process of the image processing apparatus 1-1, for example. The instruction process shown in FIG. 2 is carried out by the CPU 11 shown in FIG. 1.

In FIG. 2, a step S1 inputs the electronic mail received from the other image processing apparatuses 1-2 through 1-N via the network 30, and decodes instructions included in the electronic mail. The instructions included in the electronic mail include a record instruction, a reproduce instruction, a status request and the like. The record instruction includes an apparatus name of a target image processing apparatus, a specified recording material such as a television channel, a start time and an end time. The reproduce instruction includes an apparatus name of a target image processing apparatus, a specified reproducing material such as a file name, a start time and an end time. The status request includes an operating state of the image processing apparatus such as a recording state, a reproducing state and a standby state, a vacant area (vacant memory capacity) of the image recording medium 17, and a list of reproducible contents.

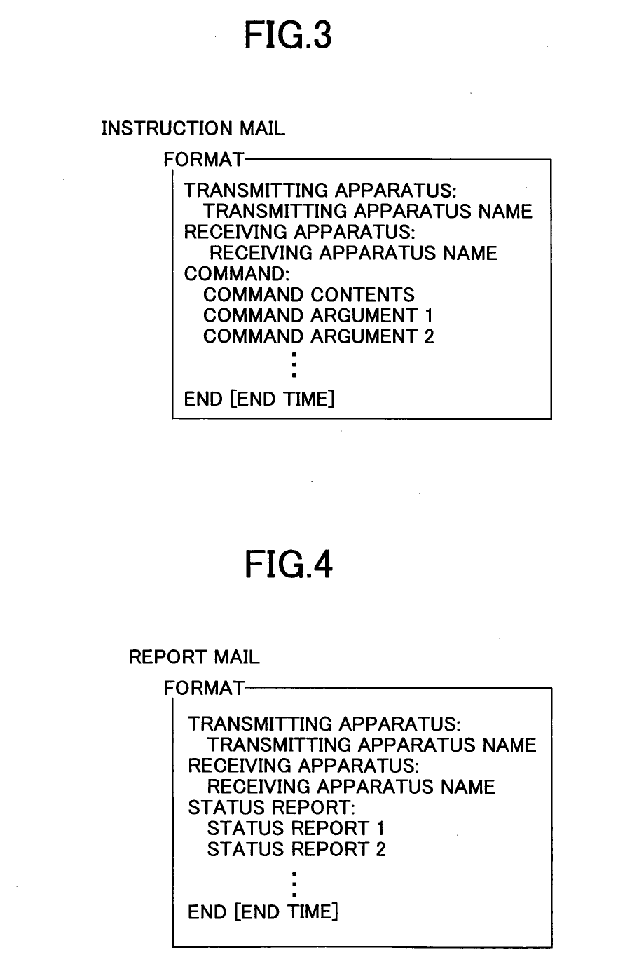

FIG. 3 is a diagram showing an embodiment of an instruction mail format. An instruction mail refers to the electronic mail including the instructions (commands) described above. As shown in FIG. 3, the instruction mail includes an transmitting apparatus name, a receiving apparatus name, command contents and corresponding command arguments (or parameters) 1, 2, . . . , and an end time. The command contents indicate the record instruction, the reproduce instruction, the status request or the like. The command argument includes the specified recording or reproducing material according to the command contents, a start time and the like.

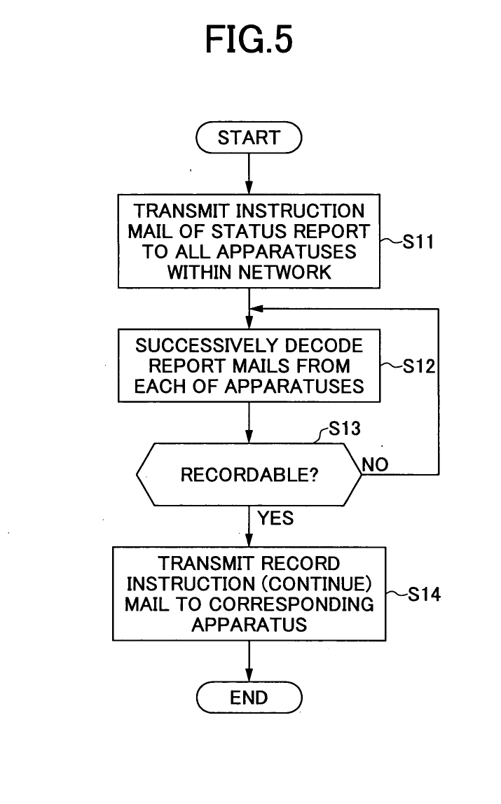

FIG. 4 is a diagram showing an embodiment of a report mail format. A report mail refers to the electronic mail which is returned in response to the instructions (commands) described above. As shown in FIG. 4, the report mail includes a transmitting apparatus name, a receiving apparatus name, status reports 1, 2, . . . , and an end time. The status report includes a recording state, a recordable state, a reproducing state, a reproducible state, a standby state, a vacant area (or vacant memory capacity) of the image recording medium 17, existence of errors and the like.

Returning now to the description of FIG. 2, a step S2 decides whether or not the decoded instruction is a reproduce instruction with respect to the image processing apparatus 1-1. In other words, the step S2 decides whether or not the receiving apparatus name indicates the image processing apparatus 1-1. If the decision result in the step S2 is YES, a step S3 reproduces the recorded image data from the image recording medium 17 according to the decoded instruction. In addition, a step S4 returns the reproduced image data and a report mail to the image processing apparatus having the transmitting apparatus name by electronic mail, according to the decoded instruction, via the communication circuit 20 and the network 30. The process returns to the step S1 after the step S4.

On the other hand, if the decision result in the step S2 is NO, a step S5 decides whether or not the decoded instruction is a record instruction with respect to the image processing apparatus 1-1. In other words, the step S5 decides whether or not the receiving apparatus name indicates the image processing apparatus 1-1. If the decision result in the step S5 is YES, a step S6 records the image data input from the input section 27 in the image recording medium 17 according to the decoded instruction. In addition, the step S4 returns a report mail to the image processing apparatus having the transmitting apparatus name, according to the decoded instruction, via the communication circuit 20 and the network 30. The process returns to the step S1 after the step S4.

If the decision result in the step S5 is NO, a step S7 decides whether or not the decoded instruction is a status request with respect to the image processing apparatus 1-1. In other words, the step S7 decides whether or not the receiving apparatus name is the image processing apparatus 1-1. If the decision result in the step S7 is YES, step S4 returns a report mail to the image processing apparatus having the transmitting apparatus name by electronic mail, according to the decoded instruction, via the communication circuit 20 and the network 30. The process returns to the step S1 after the step S4.

On the other hand, if the decision result in the step S7 is NO, a step S8 recognizes that a format error exists, and the step S4 returns a report mail to the image processing apparatus having the transmitting apparatus name by electronic mail, according to the decoded instruction, via the communication circuit 20 and the network 30. The process returns to the step S1 after the step S4.

FIG. 5 is a flow chart for explaining a recording continue process of the image processing apparatus 1-1, for example. The recording continue process is carried out by the CPU 11 shown in FIG. 1. The recording continue process shown in FIG. 5 is started by the image processing apparatus 1-1, for example, which receives a record instruction by an instruction mail, when it is judged that the vacant area (vacant memory capacity) of the image recording medium 17 has become insufficient during the recording of the image data or, when it is predicted that the vacant area (vacant memory capacity) of the image recording medium 17 will become insufficient. The state where the vacant area (vacant memory capacity) of the image recording medium 17 is insufficient or, the state where the vacant area (vacant memory capacity) of the image recording medium 17 is predicted, may be judged by a known means when a recording time of the vacant area becomes less than or equal to a length (recording time) of the image data which is to be recorded.

In FIG. 5, a step S11 transmits an instruction mail including a status request, with respect to all of the image processing apparatuses 1-2 through 1-N which are connected via the network 30. A step S12 successively decodes the report mails received from the image processing apparatuses 1-2 through 1-N. A step S13 decides whether or not a recordable image processing apparatus, that is, an image processing apparatus which can continue the recording, exists. The process returns to the step S12 if the decision result in the step S13 is NO. If the decision result in the step S13 is YES, a step S14 transmits an instruction (continue) mail which instructs continuance of the recording to the image processing apparatus which can continue the recording, at a predetermined timing. The process ends after the step S14. The predetermined timing includes a time when the vacant area (vacant memory capacity) of the image recording medium 17 becomes less than or equal to a predetermined amount, a time when the vacant area (vacant memory capacity) of the image recording medium 17 becomes less than or equal to a predetermined amount and it is easy to section or break the image data, and the like. The time when it is easy to section break the image data is during a commercial of a television program, for example.

Accordingly, when it is judged that the vacant area (vacant memory capacity) of the image recording medium 17 is insufficient or, it is predicted that the vacant area (vacant memory capacity) of the image recording medium 17 will become insufficient, during the recording of the image data in the image processing apparatus 1-1, A search is made for an image processing apparatus which is connected to the network 30 and can continue the recording of the image data. When a predetermined image processing apparatus which can continue the recording of the image data is found, the image processing apparatus 1-1 transmits an instruction (continue) mail including a record instruction to the predetermined image processing apparatus. The predetermined image processing apparatus which receives the instruction (continue) mail continues the recording by recording the image data according to the record instruction. When the recording of the image data ends in the predetermined image processing apparatus, the predetermined image processing apparatus returns a report mail to the image processing apparatus 1-1 having the transmitting apparatus name, via the network 30, according to the decoded instruction.

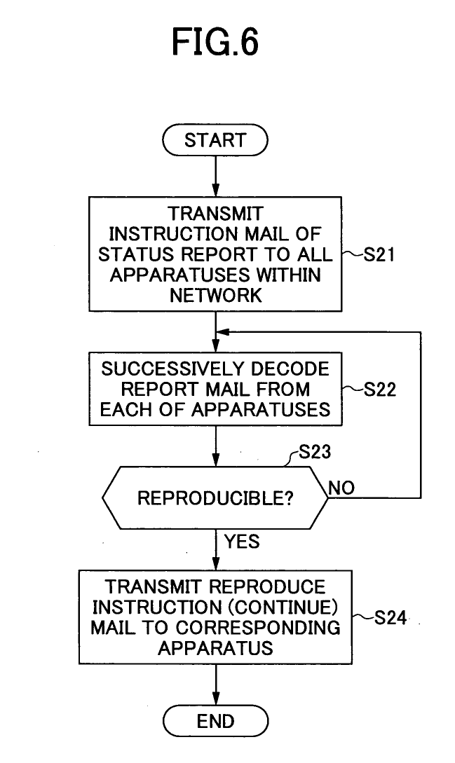

FIG. 6 is a flow chart for explaining a reproduction continue process of the image processing apparatus 1-1, for example. The reproduction continue process shown in FIG. 6 is carried out by the CPU 11 shown in FIG. 1. The reproduction continue process shown in FIG. 6 is started by the image processing apparatus 1-1, for example, which receives a reproduce instruction by an instruction mail, when it is judged that remaining image data is being recorded in another image processing apparatus during the reproduction of the image data in the image processing apparatus 1-1. Information indicating whether or not each image data is being recorded in one ore more image processing apparatuses, may be obtained from the contents of the report mail, and thus, it is possible to judge whether or not to carry out the reproduction continue process by managing the contents of the report mail.

In FIG. 6, a step S21 transmits a status request with respect to all of the image processing apparatuses 1-2 through 1-N which are connected via the network 30, and requests return of report mails. A step S22 successively decodes the report mails received from the image processing apparatuses 1-2 through 1-N. A step S23 decides whether or not a reproducible image processing apparatus, that is, an image processing apparatus which can continue the reproduction, exists. The process returns to the step S22 if the decision result in the step S23 is NO. If the decision result in the step S23 is YES, a step S24 transmits an instruction (continue) mail which instructs continuance of the reproduction to the image processing apparatus which can continue the reproduction, when the image data reproducible in the image processing apparatus 1-1 ends. The process ends after the step S24.

Accordingly, when all of the image data to be reproduced cannot be reproduced from the image recording medium 17 within the image processing apparatus 1-1 during the reproduction of the image data in the image processing apparatus 1-1, and it is judged that the remaining image data are recorded in an image recording medium 17 within another image processing apparatus, a search is made for an image processing apparatus which is connected to the network 30 and can continue the reproduction. When a predetermined image processing apparatus which can continue the reproduction is found, the image processing apparatus 1-1 transmits an instruction (continue) including the reproduce instruction to the predetermined image processing apparatus. The predetermined image processing apparatus which receives the instruction (continue) mail reproduces the remaining image data according to the reproduce instruction, to continue the reproduction. When the predetermined image processing apparatus ends the reproduction of the image data, the predetermined image processing apparatus returns a report mail to the image processing apparatus 1-1 having the transmitting apparatus name, via the network 30, according to the decoded instruction.

Therefore, the recording and reproduction can be continued by the mutually linking operations of the image processing apparatuses 1-1 through 1-N.

In this embodiment, it is assumed for the sake of convenience that the image processing apparatuses 1-1 through 1-N have the same structure. However, the image processing apparatuses 1-1 through 1-N may have mutually different structures. In addition, the image processing apparatus 1-1 may function as a master apparatus and the other image processing apparatuses 1-2 through 1-N may function as slave apparatuses, for example. In this case, the image processing (master) apparatus 1-1 may be formed by a personal computer, and the image processing (slave) apparatuses 1-2 through 1-N may be formed by video decks. When using the image processing apparatus 1-1 as the master apparatus, the contents of the report mails from each of the image processing apparatuses 1-2 through 1-N can be centrally managed, thereby making it possible to efficiently manage the information that is necessary to continue the recording and/or to continue the reproduction.

Settings which indicate which one of the image processing apparatuses 1-1 through 1-N is the master apparatus and which are the slave apparatuses, may be stored in the setting storage 15 shown in FIG. 1. In addition, the various kinds of settings stored in the setting storage 15 may include the apparatus name, the apparatus names of the image processing apparatuses 1-1 through 1-N which belong to the same group connected to the network 30, the order in which the image processing apparatuses are to be automatically selected when the image processing apparatus is not specified at the time of the recording, the order in which the image processing apparatuses are to be automatically selected when a plurality of image processing apparatuses can continue the recording or reproduction, the instruction to be processed with priority when the record instruction and the reproduce instruction are generated simultaneously with respect to the same image processing apparatus, the priority order of the image processing apparatuses which are to process the instruction with priority, and the like.

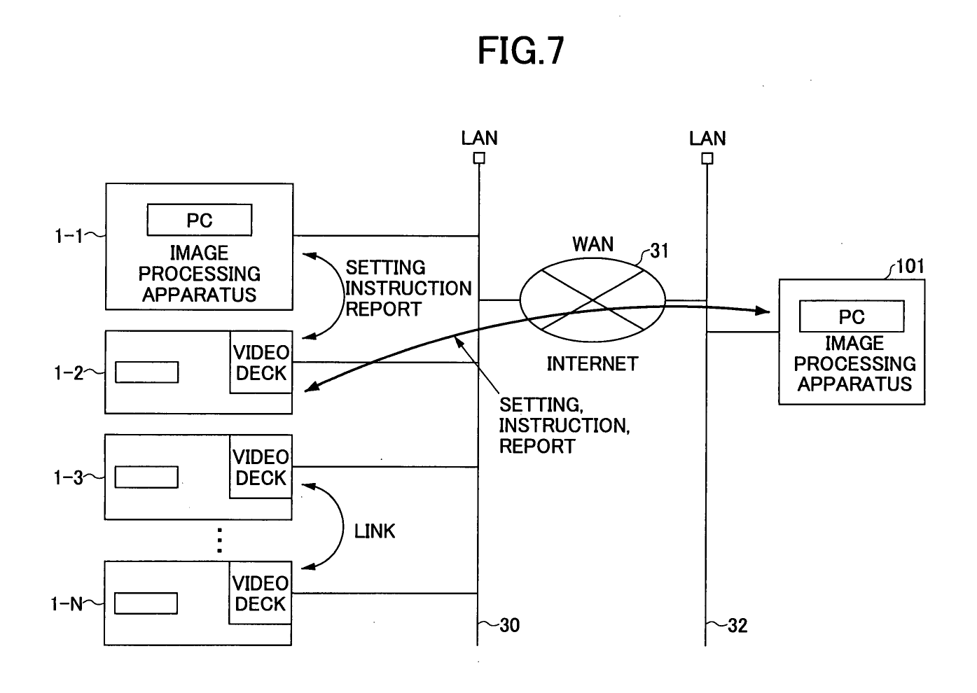

FIG. 7 is a system block diagram showing a system to which a second embodiment of the image recording and/or reproducing apparatus may be applied. In FIG. 7, those parts which are the same as those corresponding parts in FIG. 1 are designated by the same reference numerals, and a description thereof will be omitted.

In the system shown in FIG. 7, the network 30 is formed by a LAN, and the LAN 30 is connected to a LAN 32 via a WAN (Internet) 31. An image processing apparatus 101 is connected to the LAN 32. In this embodiment, it is assumed for the sake of convenience that the image processing apparatus 1-1 is formed by a personal computer, the image processing apparatuses 1-2 through 1-N are formed by video decks, and the image processing apparatus 101 is formed by a personal computer. Accordingly, in the group of the image processing apparatuses 1-1 through 1-N connected to the same LAN 30, the image processing apparatus 1-1 functions as the master apparatus, and the image processing apparatuses 1-2 through 1-N function as the slave apparatuses. However, it is of course possible for the image processing apparatuses 1-1 through 1-N and 101 to have the same structure or, mutually different structures.

In this embodiment, each of the image processing apparatuses 1-1 through 1-N receives instruction mails from the image processing apparatuses 1-1 through 1-N which are connected to the LAN 30 or, from the image processing apparatus 100 which is connected to the LAN 30 via the WAN 31 and the LAN 32, and transmits report mails to the image processing apparatuses 1-1 through 1-N. Each of the image processing apparatuses 1-1 through 1-N and 101 forms the second embodiment of the image processing apparatus.

For example, when the image processing apparatus 101 transmits a record instruction by electronic mail to the image processing apparatus 1-2, the image processing apparatus 1-2 receives the electronic mail (instruction mail) via the LAN 32, the WAN 31 and the LAN 30, and decodes the instructions included in the electronic mail. The image processing apparatus 1-2 records the image data according to the record instruction, and if necessary, links operation to one or more other image processing apparatuses 1-3 through 1-N to continue the recording. In a case where the electronic mail received by the image processing apparatus 1-2 includes an instruction related to the settings, the instructed settings are made in the image processing apparatus 1-2, and the image processing apparatus 1-2 reports information related to the continuance of the recording and the settings by a report mail to the image processing apparatus 1-1 which forms the master apparatus. In addition, the report mail with respect to the record instruction included in the electronic mail which is received by the image processing apparatus 1-2, may be transmitted from the image processing apparatus 1-2 to the image processing apparatus 101 directly or, transmitted from the image processing apparatus 1-2 to the image processing apparatus 101 via the image processing apparatus 1-1 which forms the master apparatus. Similarly, the electronic mail from the image processing apparatus 101 with respect to the image processing apparatus 1-2 may be input to the image processing apparatus 1-2 via the image processing apparatus 1-1 which forms the master apparatus.

Therefore, according to this embodiment, one or a plurality of image processing apparatuses may be controlled via one or a plurality of networks, and it is possible to continue the recording and reproduction by mutually linking operations of the plurality of image processing apparatus which are connected via one or more networks.

In each of the embodiments described above, information are exchanged among the image processing apparatuses in the form of electronic mail, but the method of exchanging the information is of course not limited to the use of the electronic mail.

Further, the present invention is not limited to these embodiments, but various variations and modifications may be made without departing from the present invention.

What is claimed is:

1. An image recording and/or reproducing method adapted to a system comprising a plurality of image processing apparatuses which have functions of recording and/or reproducing image data and are coupled via one or a plurality of networks, comprising:
transmitting an instruction from a first image processing apparatus with respect to a second image processing apparatus by an electronic mail; and
returning a status report related to the second image processing apparatus to the first image processing apparatus by an electronic mail, in response to the instruction received by the electronic mail.

2. The image recording and/or reproducing method as claimed in claim 1, further comprising:
continuing recording or reproduction by linking operation with an image processing apparatus which is other than the second image processing apparatus and is coupled to said one or plurality of networks, depending on a state of the second image processing apparatus.

3. The image recording and/or reproducing method as claimed in claim 1, wherein:
the instruction included in the electronic mail includes one of a record instruction, a reproduce instruction and a status request;
the record instruction includes an apparatus name of the second image processing apparatus, a specified recording material, a start time and an end time;
the reproduce instruction includes an apparatus name of the second image processing apparatus, a specified reproducing material, a start time and an end time; and
the status request includes an operating state of the second image processing apparatus, a vacant memory capacity within the second image processing apparatus, and a list of reproducible contents,
said operating state of the second image processing apparatus including a recording state, a reproducing state and a standby state.

4. The image recording and/or reproducing method as claimed in claim 1, wherein the first image processing apparatus functions as a master apparatus, and one or a plurality of image processing apparatuses coupled to a network to which the first image processing apparatus is coupled function as slave apparatuses.

5. An image recording and/or reproducing method adapted to a system comprising a plurality of image processing apparatuses which have functions of recording and/or reproducing image data and are coupled via one or a plurality of networks, comprising:
transmitting an instruction from a first image processing apparatus with respect to a second image processing apparatus;
returning a status report related to the second image processing apparatus to the first image processing apparatus, in response to the received instruction; and
continuing recording or reproduction by linking operation with an image processing apparatus which is other than the second image processing apparatus and is coupled to said one or plurality of networks, depending on a state of the second image processing apparatus.

6. An image processing apparatus connectable to a network and having functions of recording and/or reproducing image data, comprising:
a unit to transmit an instruction with respect to a receiving end image processing apparatus via the network by an electronic mail; and
a unit to return a status report to a transmitting end image processing apparatus via the network by an electronic mail, in response to the instruction of the electronic mail which is received via the network.

7. The image processing apparatus as claimed in claim 6, further comprising:
a unit to continue recording or reproduction by linking operation with one or a plurality of other image processing apparatuses which are coupled to the network, depending on a state of the image processing apparatus.

8. The image processing apparatus as claimed in claim 6, wherein:
the instruction included in the electronic mail includes one of a record instruction, a reproduce instruction and a status request;
the record instruction includes an apparatus name of the receiving end image processing apparatus, a specified recording material, a start time and an end time;
the reproduce instruction includes an apparatus name of the receiving end image processing apparatus, a specified reproducing material, a start time and an end time; and
the status request includes an operating state of the receiving end image processing apparatus, a vacant memory capacity within the receiving end image processing apparatus, and a list of reproducible contents,
said operating state of the receiving end image processing apparatus including a recording state, a reproducing state and a standby state.

9. An image processing apparatus connectable to a network and having functions of recording and/or reproducing image data, comprising:
a unit to transmit an instruction with respect to a receiving end image processing apparatus via the network, when said image processing apparatus operates as a transmitting end;
a unit to return a status report to a transmitting end image processing apparatus via the network, in response to the instruction which is received via the network, when said image processing apparatus operates as a receiving end; and
a unit to continue recording or reproduction by linking operation with an image processing apparatus which is coupled to the network aid is other than the receiving end image processing apparatus, depending on a state of said image processing apparatus when said image processing apparatus operates as the receiving end.
